(19) United States
(12) Patent Application Publication
(10) Pub. No.: US 2007/0088815 A1
(43) Pub. Date: Apr. 19, 2007

(54) Automated setup and test confirmation of dynamic DNS service

(76) Inventors: Kenneth Ma, Cupertino, CA (US); Bhupesh D. Kharwa, San Ramon, CA (US)

Correspondence Address: MCANDREWS HELD & MALLOY, LTD, 500 WEST MADISON STREET, SUITE 3400, CHICAGO, IL, 60661, US

(21) Appl. No.: 11/249,190

(22) Filed: Oct. 13, 2005

(51) Int. Cl. G06F 15/173

(52) U.S. Cl. 709/224

(57) ABSTRACT

Herein described is a system and method for providing automated setup and testing of DDNS services provided by a DDNS service provider. The method comprises using first graphical user interface to generate an account. Once an account is generated, the user may input his user identification and password information into one or more inputs fields provided by the first graphical user interface. After the user logs in, a second graphical user interface provides one or more input fields in which the user may create a DDNS service. Subsequently, the newly created service is tested and a confirmation is provided to the user. The system comprises a data storage device used for storing a software used to generate the first and second graphical user interfaces. The system further comprises a processor used for executing the software.

### BACKGROUND OF THE INVENTION

When an Internet service provider assigns an IP address to a device, the IP address is often dynamically assigned, and as a result, the IP address may vary over time. An Internet service subscriber may use one or more devices in his local or private network that require access from one or more devices that are external to his local or private network. The external devices may require access to one or more services provided by the one or more devices residing within the subscriber's private network. The services may comprise e-mail services, web services, and/or FTP services, for example. The subscriber may wish to provide these services to one or more users outside of his private network. When implementing such services in a dynamic WAN IP environment, the subscriber must also subscribe to a dynamic DNS (DDNS) provider in addition to the Internet service provider. The DDNS provider facilitates the routing of packets to the subscriber's device even though the IP address of the subscriber's device may be continuously changing. As a consequence, the one or more devices external to the private network are able to continually access the one or more services provided by the one or more devices in the private network.

Unfortunately, the act of subscribing to a DDNS provider may be an arduous process requiring a number of steps. For example, the DDNS subscriber may be required to receive and utilize one or more parameters provided by one or more e-mails that are transmitted by the DDNS service provider. The one or more parameters may comprise data such as user name, e-mail, and/or login information. Furthermore, there may be reliability issues with respect to accessibility of the one or more services provided by the one or more devices in the private network.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the invention provide at least a system and a method that allow a user to automate the setup and testing of dynamic DNS services. The various aspects of the invention are substantially shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a block diagram illustrating a typical system that employs automated setup and testing of dynamic DNS services provided by a DDNS service provider, such that changes in the IP address of a device/router may be continuously mapped to a host name/domain name, in accordance with an embodiment of the invention.

FIG. 2 is a block diagram illustrating a typical system that utilizes automated setup and testing of dynamic DNS services provided by a DDNS service provider, such one or more devices in a private LAN (local area network) may be accessible from the Internet, in accordance with an embodiment of the invention.

FIG. 3 is a graphical user interface (GUI) used for automated setup of and access to one or more dynamic DNS accounts, in accordance with an embodiment of the invention.

FIG. 4 is a graphical user interface (GUI) used for automated setup of new services and viewing of available services provided by a DDNS service provider, in accordance with an embodiment of the invention

FIG. 5 is an operational flow diagram describing the automated setup and testing of a DDNS service using a client application executed at a device by a user, in accordance with an embodiment of the invention.

FIG. 6 is a system block diagram of either the device/router shown in FIG. 1, or one of the one or more devices shown in FIG. 2, in accordance with an embodiment of the invention.

FIG. 7 is an operational block diagram describing how a new DDNS account is generated by way of using the Account Setup/Access Page illustrated in FIG. 3, in accordance with an embodiment of the invention.

FIG. 8 is an operational flow diagram describing the sequence of steps used to create one or more DDNS services, after an associated account is established, in accordance with an embodiment of the invention.

FIG. 9 is an operational flow diagram describing the sequence of steps used to perform a verification or test of the DDNS service(s) provided by one or more DDNS service providers, in accordance with an embodiment of the invention.

### DETAILED DESCRIPTION OF THE INVENTION

Various aspects of the invention provide at least a system and method of automated setup and testing of DDNS (dynamic domain name system) services provided by a DDNS service provider. In a representative embodiment, the automated setup and testing is performed by way of using one or more user-friendly graphical user interfaces (GUIs). In a representative embodiment, the GUIs are provided to a user when the user “clicks” on an icon shown on a desktop screen of a computing device. When a user actuates the icon (by way of “clicking” using a mouse, for example), a set of computer instructions is executed such that the GUIs are displayed to the user. The icon may be provided when the computing device executes a boot program when the computing device is booted up, for example. The GUIs provide one or more input fields and/or buttons in which the aforementioned DDNS services may be automatically setup and tested. The one or more services that are provided by the DDNS service provider comprises the dynamic updating of the IP address associated with a device's host name and domain name. This type of updating may be required when a user subscribes to an Internet service that provides dynamic WAN IP addresses as opposed to static WAN IP addresses. The Internet service provider may utilize a protocol known as DHCP for provisioning IP addresses to its one or more subscribers. When subscribing to a service that provides such dynamic IP addresses, any change in the subscriber's IP address (i.e., public or WAN IP address) must be dynamically updated at one or more domain name servers such that one or more devices located outside of the subscriber's network may be able to continuously communicate to a subscriber's device that is associated with the dynamic IP address. Any change in the IP address is updated to the domain name servers by the DDNS service provider. The DDNS service provider appropriately maps the dynamic IP address to a user chosen host name/domain name.

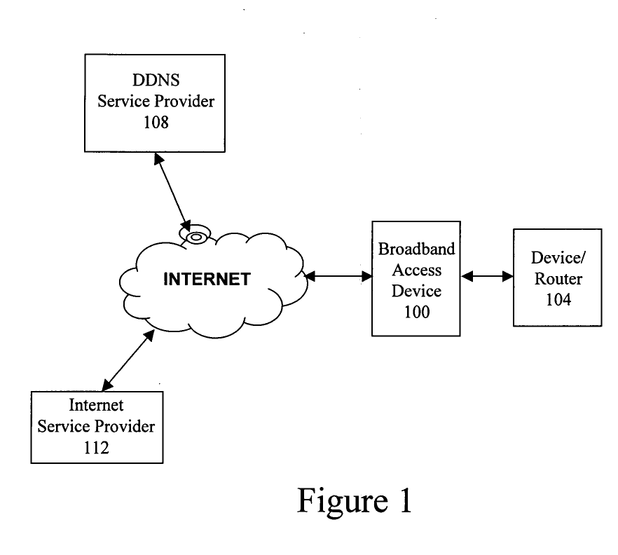

FIG. 1 is a block diagram illustrating a typical system that employs automated setup and testing of dynamic DNS services provided by a DDNS service provider 108, such that changes in the IP address of a device/router are continuously mapped to a host name/domain name, in accordance with an embodiment of the invention. As shown, the system comprises a broadband access device 100, a device with integrated router (DIR) 104 (i.e., a device incorporating routing functions), a DDNS service provider 108, and an Internet service provider 112. The broadband access device 100 may comprise a cable modem or DSL (digital subscriber line) modem, for example. The broadband access device 100 provides high speed Internet access to a private network. The private network comprises the DIR 104. The broadband access device 100 also functions as an interface between the private network and one or more public access networks. The WAN interface of the DIR 104 is assigned an available wide area network (WAN) IP address by the Internet service provider 112. The WAN IP address may change because the Internet service provider 112 assigns an available WAN IP address to the DIR 104 at a time when the DIR 104 is powered up or when a user logs into the DIR 104, for example. The DIR 104 may be any component or computing device capable of being networked that incorporates routing or switching functions. The DIR 104 may comprise a computer that is configured to operate and function as a web server, FTP server, or e-mail mail server, for example. The DIR 104 may comprise a digital video recorder (DVR), set-top-box (STB), personal computer, network camera, media server, or network storage device, for example. The DDNS service provider 108 facilitates the tracking and updating of any changes that occur to the DIR's IP address, such that one or more devices communicatively coupled to the Internet may communicate to the DIR 104. Any new IP addresses assigned to the DIR 104 is updated and mapped to a user-designated host name/domain name. The DDNS service provider 108 may obtain information related to a newly assigned WAN IP address (provided by an Internet service provider) by way of one or more message updates generated from the DIR 104 to the DDNS service provider, for example. The Internet service provider 112 provides a WAN IP address to the DIR 104 by way of the broadband access device 100. The DIR 104 may provide routing functionality to one or more LAN devices that are communicatively coupled to the DIR 104.

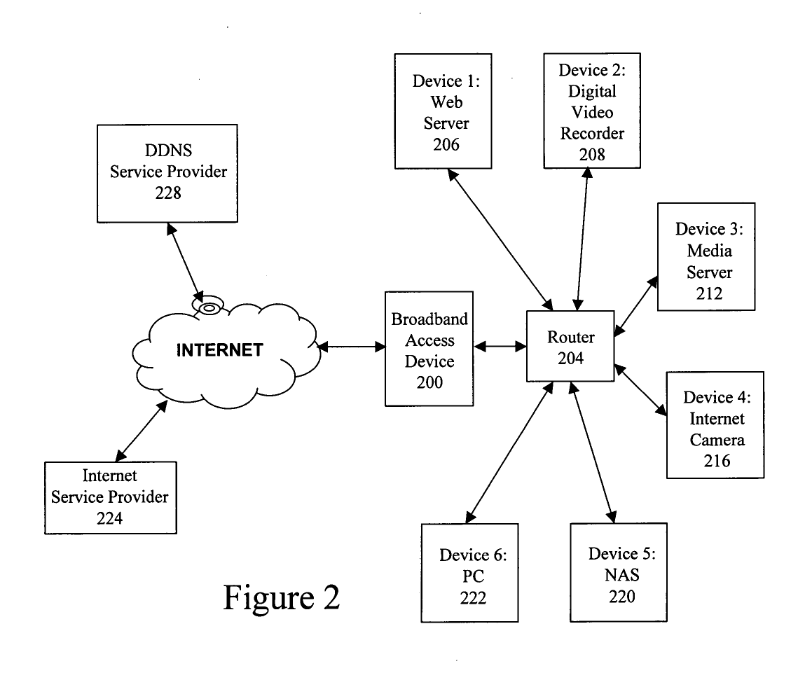

FIG. 2 is a block diagram illustrating a typical system that utilizes automated setup and testing of dynamic DNS services provided by a DDNS service provider 228, such one or more devices in a private LAN (local area network) may be accessible from the Internet, in accordance with an embodiment of the invention. The system comprises a broadband access device 200, a router 204, an Internet service provider 224, a DDNS service provider 228, and a number of local area network devices 206, 208, 212, 216, 220. In this representative embodiment, the local area network devices comprise a web server 206, a digital video recorder (DVR) 208, a media server 212, an Internet camera 216, a network attached storage device (NAS) 220, and a personal computer 222. The NAS 220 may comprise a data storage facility that may be accessed by one or more devices that are communicatively coupled (by way of one or more packet switched networks) to the NAS 220. The broadband access device 200 may comprise a cable modem or DSL (digital subscriber line) modem, for example. The broadband access device 200 provides high speed Internet access to a private network. The router 204 may be communicatively coupled to the one or more devices in a local area network. These devices may comprise the web server 206, the digital video recorder (DVR) 208, the media server 212, the Internet camera 216, the network attached storage device (NAS) 220, and the personal computer 222, for example. These devices may be accessible to one or more devices external to the private local area network as a result of employing DDNS services provided by the DDNS service provider. The Internet service provider 224 provides a WAN IP address to the router 204. The router 204 provides port forwarding functions such that a designated port is opened for each of the devices 206, 208, 212, 216, 220 connected to the router 204. In this fashion, one or more network devices outside of the private local area network may be able to communicate to each of the devices 206, 208, 212, 216, 220, 222 by way of using the DDNS services.

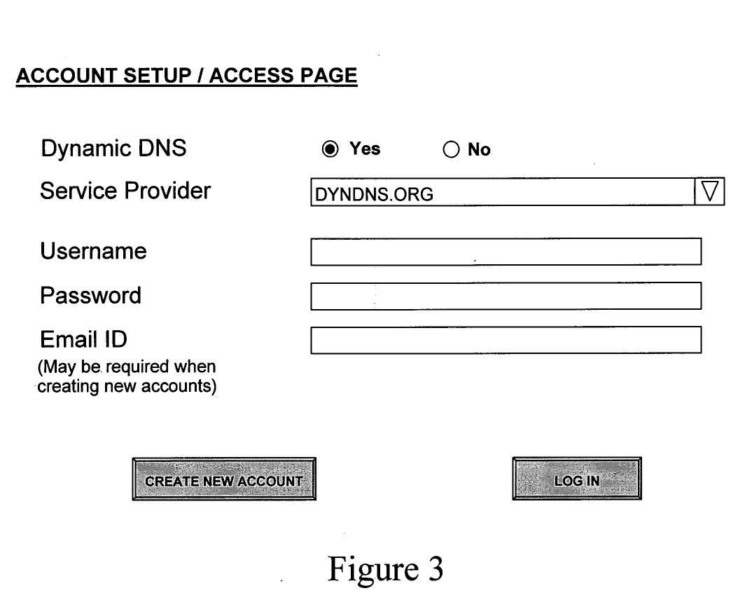

FIG. 3 is a graphical user interface (GUI) used for automated setup of and access to one or more dynamic DNS accounts, in accordance with an embodiment of the invention. As illustrated, the GUI may be described as an “Account Setup/Access Page”. The Account Setup/Access Page comprises a number of input fields, controls, pull down menus, and buttons. The first control in the Account Setup/Access Page allows a user to select whether the WAN IP address requires DDNS services. If the user desires DDNS services, he selects the “yes” radio button as shown in FIG. 3. Otherwise, he selects the “no” radio button. The Account Setup/Access Page provides for a pull down field in which a user may select an appropriate DDNS service provider. The Account Setup/Access Page indicates that DYNDNS.ORG has been selected as the DDNS service provider of interest to the user. During account setup, the username field allows the user to input a username and the password field allows the user to input a desired password when a user establishes a new account. An e-mail ID field may be used to input the user's e-mail address when the user establishes a new account. After an account has been established, the user may login to his account by inputting the username and password into the username field and password field.

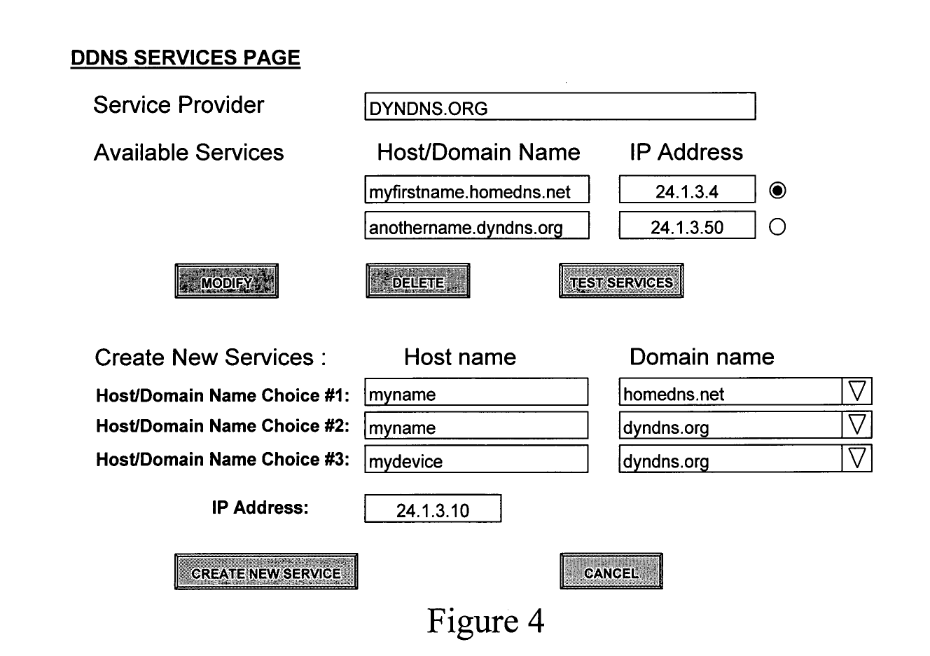

FIG. 4 is a graphical user interface (GUI) used for automated setup of new services and viewing of available services provided by a DDNS service provider, in accordance with an embodiment of the invention. The GUI of FIG. 3 proceeds to the GUI of FIG. 4 after a login is successful. The GUI of FIG. 4 may be referred to as a “DDNS Services Page”. In a portion of the DDNS Services Page, a user may input one or more desired host names and domain names (or host/domain names) associated with a new DDNS service. In the embodiment pictured in FIG. 4, the one or more host names and domain names are input into one or more fields in the bottom portion of the DDNS Services Page. A field within the DDNS Services Page may also be provided for the user to input an IP address associated with the requested host names and domain names. The host names and domain names may be input in order of priority and the IP address may be associated with the first available host/domain name combination, starting with the first entry, “Host Name Choice #1”, as shown in FIG. 4. In the representative embodiment of FIG. 4, a user has input three possible host name and domain name choices. For example, the first host name and domain name choice fields are populated using “myname” as the host name and “homedns.net” as the domain name. The second host name and domain name choice fields are populated using “myname” as the host name and “dyndns.net” as the domain name. The third host name and domain name choice fields are populated using “mydevice” as the host name and “dyndns.net” as the domain name. After the desired host name and domain name choices are input into the one or more fields, the user depresses the “Create New Service” button. In another portion of the DDNS Services Page, the available services which have been established by the user are displayed. In the representative embodiment shown in FIG. 4, there are two available services created by the user: “myfirstname.homedns.net” and “anothername.dyndns.org”. The respective IP addresses associated with the two available services are 24.1.3.4 and 24.1.2.50. When a new service has been successfully created, the available services portion of the DDNS Services Page is updated to reflect the newly created service.

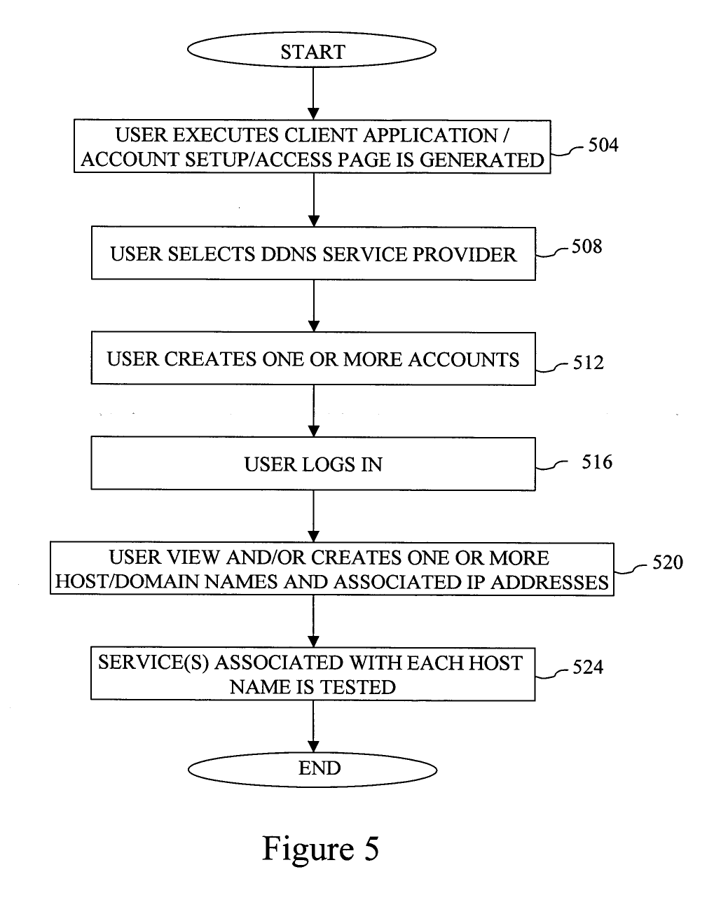

FIG. 5 is an operational flow diagram describing the automated setup and testing of a DDNS service using a client application executed at a device by a user, in accordance with an embodiment of the invention. In a representative embodiment, the device may comprise the device/router previously described in relation to FIG. 1. In another representative embodiment, the device may comprise any one of the one or more devices described in FIG. 2. For example, the one or more devices may comprise a web server, a digital video recorder, a media server, an Internet camera, or network attached storage device (NAS). At step 504, the user executes a client application at the device such that the Account Setup/Access Page, previously described in FIG. 3, is generated. In a representative embodiment, the client application may be executed when the device is powered-up and operational. In a representative embodiment, the client application may be executed when the user depresses or clicks on an icon displayed on a screen. At step 508, the user selects an appropriate DDNS services provider. The DDNS services provider may be selected from a pull-down list provided by the Account Setup/Access Page, as illustrated in FIG. 3. In a representative embodiment, the DDNS services provider selected may be associated with an existing account, in which case the user may be redirected to a “log in screen” providing a “log in button”, as was previously shown in FIG. 3. In another representative embodiment, the DDNS services provider selected may be used to create a new account. In the representative embodiment of FIG. 5, at step 512, the user may create an account for each of the one or more DDNS service providers provided by the pull-down list. Alternatively, the user may log into the one or more existing accounts using the “log in screen”. After the user has created or established at least one account, at step 516, the user logs in to a selected account, for example, by depressing the “log in button” shown in FIG. 3 of the Account Setup/Access Page. Next, at step 520, the user is redirected to a new screen, such as the DDNS Services Page, as was previously described in reference to FIG. 4. The user may either view and/or create one or more DDNS services by way of inputting one or more host/domain names using the DDNS Services Page. The user may create a host/domain name by associating the host/domain name with an IP address. In reference to FIG. 1, the Internet service provider provides an IP address to the device/router. In reference to FIG. 2, an IP address is provided to the router by the Internet service provider, and the router may employ a network address translation when issuing local area network IP addresses to the one or more devices previously described. Of course, in either embodiment, the WAN IP address may change over time. The WAN IP address may change, for example, when a user boots-up or logs onto the device/router of FIG. 1 or the one or more devices of FIG. 2. Next, at step 524, the one or more DDNS services that are created are operationally tested or verified. Each of the one or more DDNS services may be tested immediately after an account is created.

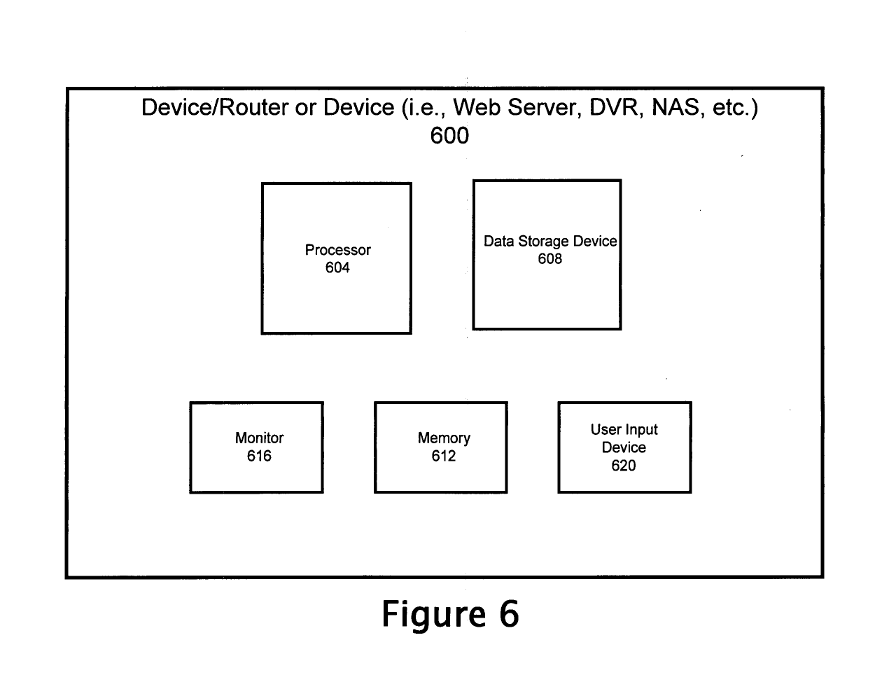

FIG. 6 is a system block diagram of either the device/router shown in FIG. 1, or one of the one or more devices shown in FIG. 2 600, in accordance with an embodiment of the invention. As described earlier, the one or more devices may comprise one or more web servers, DVRS, Internet cameras, NAS′, or any other like computing device. For the sake of simplicity, FIG. 6 will be described in terms of the device/router referenced in FIG. 1, although it may alternatively refer to any one of the one or more devices described in reference to FIG. 2. The device/router 600 comprises a processor 604, a data storage device 608, a memory 612, a monitor 616, and a user input device 620. The data storage device 608 may store software, termed a client software, which may be executed by way of control provided by the processor 604. The data storage device 608 may comprise a hard disk drive, for example. The client software may be executed when the device/router 600 is powered-up or booted-up, for example. In a representative embodiment, a user may initiate execution of the client software by invoking a command. The command may occur when the user depresses an icon or clicks on an icon displayed on the monitor 616, for example. The client software may be loaded from the data storage device 608 into the memory 612 during the power-up or boot-up process. The processor 604 may utilize the memory 612 and data storage device 608 as data storage components to facilitate execution of the software or client software. The user input device 620 may be used by a user to input one or more characters and/or commands. The input device 620 may comprise a keyboard or a computer mouse, for example. One or more characters and/or commands that are input by a user may be visually displayed using the monitor 616. When executed, the client software facilitates and/or enables the use of the Account Setup/Access Page and the DDNS Services Page previously described in reference to FIGS. 3, 4, and 5. The client software may facilitate communication between the device/router 600 and the DDNS service provider's website or URL. The client software may provide updates to the DDNS service provider when a new IP address is assigned to the device/router 600 by its Internet service provider. Optionally, the client software may be used in conjunction with DDNS server software residing in a server at the DDNS service provider. The DDNS server software may be loaded in a data storage device such as a hard disk drive, at the DDNS service provider. The DDNS software may be executed by the DDNS service provider such that communication and/or one or more operations between the device/router 600 and the DDNS service provider may successfully occur. The DDNS service provider may configure and maintain the DDNS server software.

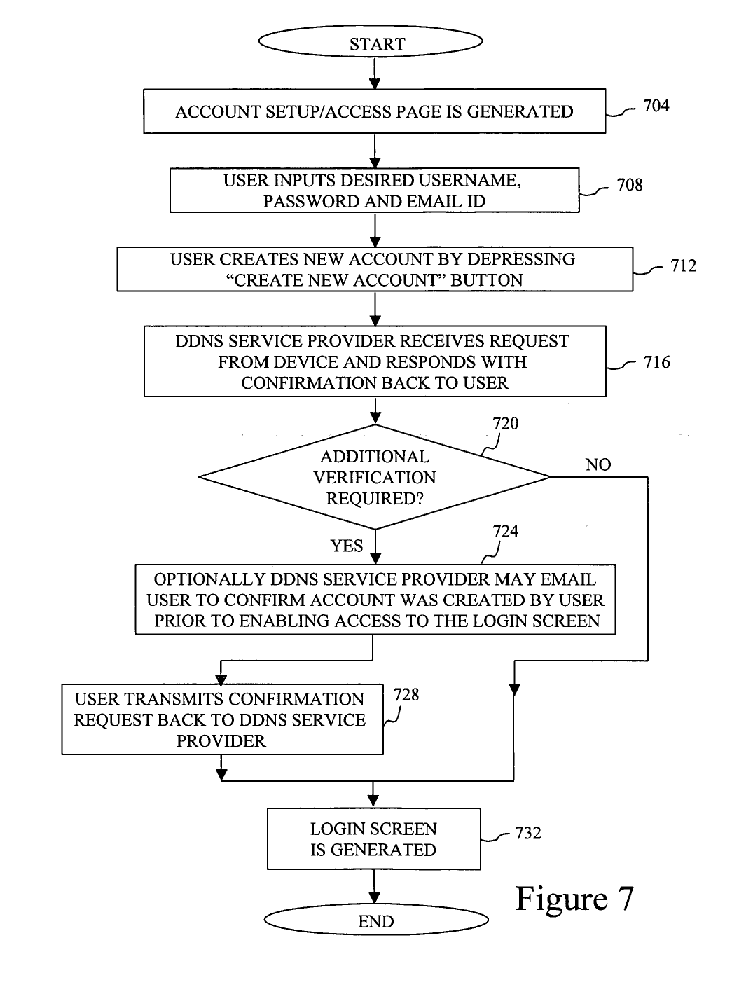

FIG. 7 is an operational block diagram describing how a new DDNS account is generated by way of using the Account Setup/Access Page illustrated in FIG. 3, in accordance with an embodiment of the invention. FIG. 7 may provide a more detailed description of steps 504, 508, and 512, as previously described in reference to FIG. 5. At step 704, the Account Setup/Access Page is generated when a user initiates execution of the client software resident in the device/router of FIG. 1 or in the one or more devices of FIG. 2. After the user selects an appropriate DDNS service provider from a pull-down list, at step 708, the user inputs a desired username, password, and e-mail identifier (ID) into the one or more fields shown in FIG. 3. The username and password will be used in the future to gain access to the account associated with the selected DDNS service provider. Next, at step 712, the user creates a new account by depressing the “Create New Account” button as shown in FIG. 3, such that a request is generated to the DDNS service provider. Next, at step 716, the DDNS service provider receives the request from the device/router (or one of the one or more devices) and responds with a confirmation message back to the user. The confirmation message may be in the form of a “log in screen” showing a visible “log in” button as illustrated in FIG. 3. Prior to generating the visible log in screen, at step 720, the DDNS service provider may request that additional verification be required. Optionally, if additional verification is required, the process continues with step 724, at which the DDNS service provider may e-mail a request that the user provides a confirmation message. At step 728, the responds by sending an acknowledgement to a particular e-mail address of the DDNS service provider, for example. After the DDNS service provider receives the acknowledgement, the log in screen may be generated and displayed to the user, as indicated at step 732. If, at step 720, no additional verification is required, the process continues at step 732, at which the log in screen is generated for display to the user.

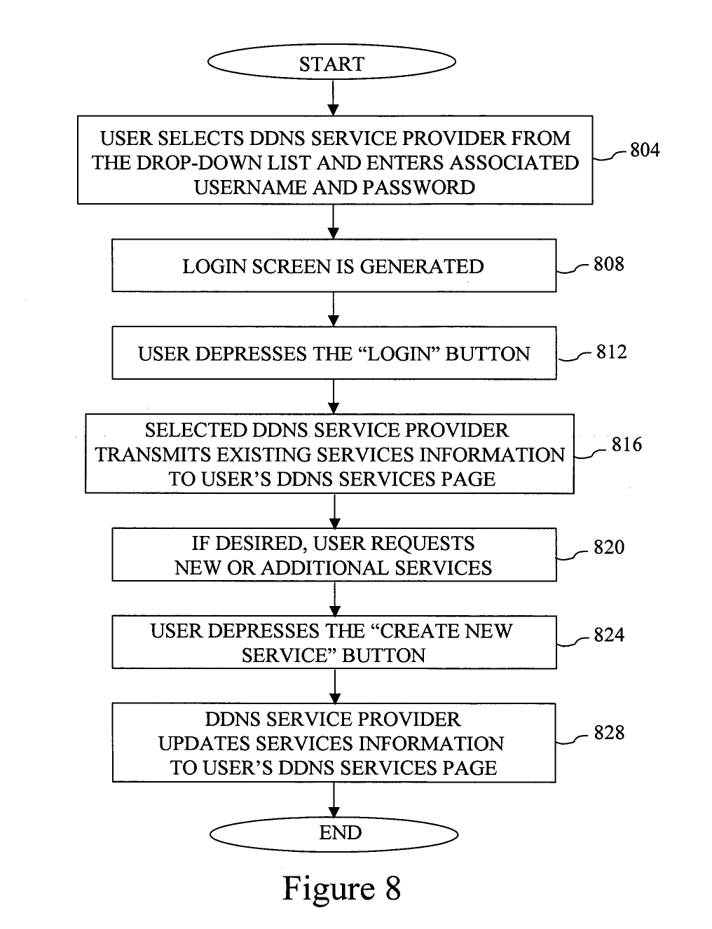

FIG. 8 is an operational flow diagram describing the sequence of steps used to create one or more DDNS services, after an associated account is established, in accordance with an embodiment of the invention. FIG. 8 may provide a more detailed description of steps 516 and 520, as previously described in reference to FIG. 5. In this representative embodiment, the process commences at step 804, one or more DDNS service providers associated with the at least one existing account may be subsequently selected from the pull-down list of the Account Setup/Access Page. In a representative embodiment, the client software in the device/router or device may be configured such that the log in screen may appear only after the user selects a DDNS service provider from the pull-down list and inputs an appropriate username and password. In a representative embodiment, the log in screen may be automatically generated for a device/router or device having at least one existing account with one or more DDNS service providers. At step 808, a log in screen (as previously described in reference to FIG. 7 and illustrated in FIG. 3) is generated. Next, at step 812, the user depresses the log in button to generate the DDNS Services Page. At step 816, the selected DDNS services provider transmits existing services information to the user's DDNS Services Page. A representative embodiment of the DDNS Services Page may be referenced in FIG. 4. At step 820, the user may request a new or additional DDNS service by inputting a desired host/domain name into the host name and domain name input fields of the DDNS Services Page. At step 824, the user depresses the “Create New Service” button to effect creation of a new DDNS service. Next, at step 828, the associated DDNS service provider responds to the request by updating the DDNS Services Page to reflect the successful addition of the requested DDNS service. If desired, the user may create another host/domain name by repeating steps 808, 812, 816, 820, 824, 828.

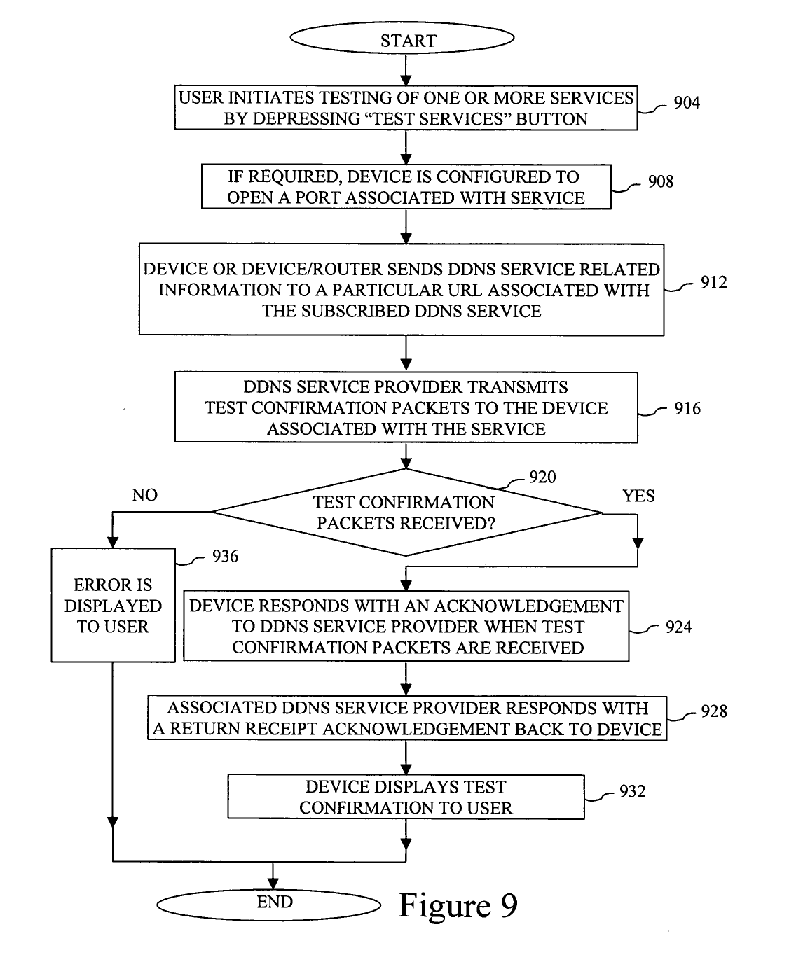

FIG. 9 is an operational flow diagram describing the sequence of steps used to perform a verification or test of the DDNS service(s) provided by one or more DDNS service providers, in accordance with an embodiment of the invention. At step 904, a user initiates testing of a DDNS service by depressing the “Test Services” button, as illustrated in FIG. 4. In a representative embodiment, the testing occurs after a new DDNS service is created in the “Create New Service” portion of the DDNS services page. The user may select the DDNS service to be tested by selecting one of the one or more available DDNS services using the DDNS service page. If, at step 908, a device positioned behind a router (as shown in the system diagram of FIG. 2) requires DDNS service, an associated port is opened using an unreserved port number. Next, at step 912, the device (in the system of FIG. 2) or device/router (in the system of FIG. 1) sends DDNS service related information to the DDNS service provider. The DDNS service related information may comprise host name, domain name, IP address, and port number, for example. The DDNS service related information may be transmitted to a particular URL of the DDNS service provider. The DDNS service provider may provide support for this URL. At step 916, in response to the device or device/router, the DDNS service provider transmits test confirmation packets to the device or device/router associated with the DDNS service. Thereafter, at step 920, the device or device/router assesses whether or not the test confirmation packets were successfully received. The type and number of packets used in the transmission may be pre-determined by the manufacturer of the client software or by the DDNS service provider, for example. If at step 920, the correct packets are received, the process continues with step 924, at which the device or device/router responds with an acknowledgement back the DDNS service provider. Next, at step 928, the associated DDNS service provider responds with a return receipt response back to the device. Thereafter, at step 932, the device displays a confirmation to the user of the device or device/router, that the DDNS services are operational. If, at step 920, the appropriate test confirmation packets were not received, then the process commences at step 936, at which an error is displayed to the user. The user may seek corrective measures when such an error is displayed.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for automatically provisioning and testing DDNS services comprising:
generating at least one graphical user interface;
using said at least one graphical user interface to establish an account;
using said at least one graphical user interface to establish a host name/domain name, said host name/domain name associated with a first device within a private network, said host name/domain name used to identify said first device by a second device, said second device located external to said private network, said host name/domain name mapped to an IP address assigned to said first device; and
verifying communication between said second device and said first device after said IP address of said first device has changed.

2. The method of claim 1 wherein said first device comprises a router or said first device incorporates routing functionality.

3. The method of claim 2 wherein said first device comprises either a digital video recorder, media server, Internet camera, personal computer, or a network storage device.

4. The method of claim 2 wherein said first device comprises a web server, e-mail server, or FTP server.

5. The method of claim 1 wherein said first device communicates to said second device by way of a router.

6. The method of claim 5 wherein said first device and said router communicate by way of port forwarding.

7. The method of claim 5 wherein said first device comprises either a digital video recorder, media server, Internet camera, or a network storage device, or a personal computer (PC).

8. The method of claim 5 wherein said first device comprises a web server, e-mail server, or FTP server.

9. The method of claim 1 wherein said first graphical user interface provides one or more input fields, said one or more input fields used to input user identification and one or more passwords.

10. The method of claim 1 wherein said at least one graphical user interface provides one or more input fields, said one or more input fields used to input a desired host name/domain name associated with said first device.

11. A method of verifying host name/domain name to IP address mapping, said mapping provided by a DDNS service provider, said method comprising:
transmitting DDNS service information from a device to a URL of said DDNS service provider;
using said DDNS service information by said DDNS service provider to generate a first message addressed to said device;
receiving said first message by said device;
transmitting a second message from said device to said DDNS service provider after acknowledging receipt of said first message back to said DDNS service provider;
receiving a third message by said device from said DDNS service provider indicating that said second message was received by said DDNS service provider;
displaying a fourth message by said device, said fourth message indicating that said mapping is proper functioning; and
displaying a fifth message by said device if said first message is not received by said device, said fifth message indicating that an error has occurred.

12. The method of claim 11 wherein said device incorporates routing functionality.

13. The method of claim 11 wherein said DDNS service information comprises said host name/domain name and said IP address.

14. The method of claim 11 wherein said device communicates to said DDNS service provider by way of a router.

15. The method of claim 14 further comprising opening an unreserved port of a device, said device associated with said host name/domain name, said unreserved port associated with a port number.

16. The method of claim 15 wherein said unreserved port comprises a TCP/IP port.

17. The method of claim 15 wherein said DDNS service information comprises said host name/domain name, said IP address, and said port number.

18. A system for automating the setup and testing of DDNS services provided by a DDNS services provider comprising:
a data storage device within a first device of a private network, said data storage device used for storing a first software;
a processor within said first device for executing said first software, said first software capable of generating at least one graphical user interface wherein said at least one graphical user interface is used to establish an account, and said at least one graphical user interface is used to establish a host name/domain name, said host name/domain name associated with said first device, said first software used for verifying communication between a second device external to said private network and said first device after an IP address assigned to said first device by an Internet service provider has changed.

19. The system of claim 18 wherein said first device comprises either a digital video recorder, media server, Internet camera, or a network storage device.

20. The system of claim 18 wherein said first device comprises a web server, e-mail server, or FTP server.
